(19) United States
(12) Patent Application Publication
(10) Pub. No.: US 2009/0259563 A1
(43) Pub. Date: Oct. 15, 2009

(54) CUSTOMIZABLE METADATA AND CONTEXTUAL SYNDICATION OF DIGITAL PROGRAM MATERIAL

(75) Inventors: William Ruhnke, Brooklyn, NY (US); Lowell Feuer, Englewood, NJ (US)

Correspondence Address: SILLS CUMMIS & GROSS P.C., ONE ROCKEFELLER PLAZA, IP DEPARTMENT - 25TH FLOOR, NEW YORK, NY, 10020, US

(73) Assignee: KLIKVU INC., New York, NY (US)

(21) Appl. No.: 12/242,345

(22) Filed: Sep. 30, 2008

Related U.S. Application Data
(63) Continuation-in-part of application No. 11/159,284, filed on Jun. 22, 2005.
Application No. 11/159,284 is a continuation-in-part of application No. 11/158,878, filed on Jun. 22, 2005, now abandoned.

(51) Int. Cl. G06Q 30/00; G06F 17/30; G06Q 50/00; G06F 21/00

(52) U.S. Cl. 705/26; 707/3; 707/E17.014; 707/E17.044; 726/4

(57) ABSTRACT

A system and method for providing video and/or audio on-on demand service to owners of video and/or audio program rights for offering digital versions of those programs to web site visitors. The method or system is an Application Service Provider (ASP) model, whereby the services are provided to the video and/or audio owners over the World Wide Web and where no specifics software need reside with the video and/or audio owners. Video and/or audio programs from the owners, once converted to an appropriate digital form, are streamed over the Internet or other IP networks for viewing in real-time direct from a remote device having video and/or audio servers that store the digital programs by viewers who have purchased the right to view them. Customizable metadata is utilized to thematically and contextually identify the digital file. This metadata is searchable by a person seeking digital files for download. E-commerce transaction processing is provided on behalf of the video and/or audio owner, and revenue is appropriately conveyed to the owner and/or the web site.

### CROSS-REFERENCE TO RELATED APPLICATIONS

This application claims the benefit of U.S. patent application Ser. No. 11/159,284, filed on Jun. 22, 2008, the contents of which are incorporated herein by this reference, and U.S. patent application Ser. No. 11/158,878, filed on Jun. 22, 2005, the contents of which are incorporated by this reference.

### BACKGROUND OF THE INVENTION

1. Field of the Invention

The present invention relates to on-line services to web site visitors and consumers, and more specifically, to a system and method of providing on demand digital video and audio programs to visitors on a particular web site, screen and/or channel.

2. Prior Art

The entertainment industry imbues video and/or audio programs with rights of different types, and such rights may be held by one owner or shared with others who have an interest in the video and/or audio property or who made a contribution to the video and/or audio program's creation. In the past, any form of distribution or exhibition of the video and/or audio program required that the distributor or exhibitor be granted the specific rights to distribute or exhibit the video and/or audio, by the rights holders, and the distributor or exhibitor could be held liable if the rights were not properly secured from all. the rights holders of the video and/or audio property.

Many video and/or audio programs, though the provider may be confident that all the rights are within their power to grant, may require that extensive research or legal documentation be performed by or provided to the distributor or exhibitor to minimize the risk that the distributor or exhibitor may be liable for rights disputes. Often such legal documentation is not available in a suitable form, and the distributor or exhibitor cannot quantify their exposure to liability.

Traditionally, web sites that wished to offer video and/or audio programs to their visitors would obtain rights to exhibit the video and/or audio programs over the Internet, and may go to some expense to do so, prior to any sales. Likewise, the video and/or audio provider would negotiate the conveyance of Internet exhibition rights to the web site, typically giving their right to pass such rights to another, often compromising their ability to sell the video and/or audio program to other distribution channels. Moreover, Internet exhibition rights may not be well documented in the various contracts the filmmaker executes with those who contribute to the making of the video and/or audio program, making it legally risky for the video and/or audio owner to pass internet exhibition rights as a class to a web site or to any distributor.

Currently, web sites that offer video and/or audio over the Internet must first acquire the rights to provide such exhibition from the video and/or audio content owner or rights holder. This limits the catalog of video and/or audio offerings and a web site's ability to acquire exhibition rights. Such rights may require verification and documentation, which may be an expense and a risk for the web site, as exhibition rights may be challenged by others who participated in the making of the video and/or audio. Some video and/or audio content may not have a proper paper trail to allow verification of rights, yet the content owner may be confident that they do have all necessary rights for Internet exhibition.

Currently, Amazon.com® provides a central directory of available books, and other outside web sites may feature listings of books, where such listings initiate a transaction with Amazon.com®. When a customer uses Amazon.com® through an ordering web site, Amazon.com® forwards the customer to an Amazon.com® branded web page, to which the customer may return in the future without the ordering web site. Therefore, competition is a problem for the third party web site with the methods of the prior art.

Similarly, Car-part.com.® provides a central database and e-commerce transaction system used by junk yards to list their auto parts inventory, and each junk yard's web site draws just their own listings from the database. Current content syndication services for web sites, such as ScreamingMedia.com®, collect a fee from the web site that displays the content.

Video and/or audio content owners that have video and/or audio files or programs that they wish to provide over the Internet on a pay-per-view basis and collect fees from viewers, can either build their own pay-per-view e-commerce billing, authentication, and media servicing solution using a combination of outside service providers and in-house development, or they can provide their video and/or audio programs to a web site that already has the pay-per-view e-commerce and video and/or audio hosting service in place, such as Atom Films® or CinemaNow®. Thus, the content provider has to acquire software or pay a retainer to a hosting services provider, and has to transfer exhibition rights to a video and/or audio web site, which implicates legal issues.

Currently, peer-to-peer distribution methods, such as Grokster® or Streamcast®, provide members the opportunity to list their video and/or audio files available for delivery, and those files reside with the member and are delivered from there. Napster® maintained a central database of listings, which each user could add to, and which was parsed or filtered based on search criteria. However, Napster® provided delivery directly from a user's computer. Moreover, these peer-to-peer services display all listings of files which meet the buyer's search criteria, regardless of from which web site the buyer originates.

There are several music-on-demand video web sites that list digitized music files which they hold, sell, and deliver on behalf of the musician. These services take the transaction directly at their own web site. Current music-on-demand delivery systems, like the Amazon.com® model described above, clearly identify themselves in the transaction as the reseller. Therefore, these web sites must also assume the legal responsibilities along with the rights to the video and/or audio from the owners of the video and/or audio.

It is risky for the video and/or audio programs to sell the programs to other distribution channels, and for the distributor/exhibitor to accept distribution of the video and/or audio programs without avoiding liability. Recently, the emergence of application service providers (ASP) has led to legal decisions upholding the ASP'S role as a conduit between parties, without liability for the conduct of those parties.

### SUMMARY OF THE INVENTION

It is an object of the present invention to provide a method and system where the owners of the video and/or audio do not have to transfer rights to the video and/or audio to the web sites, and the web sites do not have to undertake the legal responsibilities involved with either selling the video and/or audio files or related sales, distribution and exhibition services, but to not be held liable for any rights disputes between parties. The present invention, as an ASP, matches buyers with sellers, and provides them with transaction services, but does not assume ownership of the seller's item(s) and does not resell them, and therefore, is not a party to the sale.

The present invention provides one or more databases containing entries which constitute listings of video and/or audio files that are available to the invention to provide to web visitors. Selected listings are made available to be displayed on different web sites, or in response to different search criteria. A web visitor may choose a listing to order and retrieve the video and/or audio file on-line. Multiple web sites can be served by one or more centralized databases, with each web site obtaining a customized listing of database entries. Selected entries from the database(s) are provided to a particular web site where they are offered to web site visitors for viewing. Web sites may use their own database or listing techniques, and incorporate code that would place a transaction through the centralized database.

The video and/or audio contents (or other media assets) are encoded into digital files, stored on servers, and listed in the database on behalf of the video and/or audio owner. Ordering of the video or audio programs can be accomplished on-line, through one or a number of web sites that use the invention to process transactions that permit the web visitor to obtain access to the video and/or audio and retrieve the video and/or audio over the Internet or other IP-type network.

The actual transaction by the web visitor to obtain the video and/or audio for viewing is consummated on behalf of the video and/or audio owner. The present invention provides transaction, storage, and delivery services to the video and/or audio owner. The ordering web site provides marketing services to the video and/or audio owner. The legal rights in regard to the delivery or exhibition of the video and/or audio remain with the buyer and seller.

The present invention allows web sites to provide marketing services to the video and/or audio owner (the seller), act as a syndication outlet for the seller's video and/or audio programs, and generate sales of video and/or audio files. The invention provides for on-line delivery of the video and/or audio file, either downloaded or streamed, and provides an accounting of the sale and delivery. Web sites participate either as ordering sites or as referrers. Ordering web sites display database entries directly and allow actual ordering of the video and/or audio files. Referrer web sites direct web visitors to pages at the appropriate ordering web site to view database entries and order video and/or audio programs.

Accordingly, a system for providing digital on-demand content to be offered on a web site is provided, the system, comprising a directory of one or more available digital files provided on a website and stored on one or more remote servers, ordering means to order one or more particular digital files, transaction processing means to accept orders placed by a customer for the one or more particular digital files, and delivering means for delivering the one or more particular digital files from the one or more remote servers to the customer.

Further, a method of providing digital on-demand content to be offered on a web site is provided, the method comprising providing a listing to a customer of available video and/or audio files stored on one or more remote servers and selected from a directory based on a variety of search or filter criteria on a web site, generating an order form on the web site for the customer, accepting orders placed by the customer on the web site for a particular video and/or audio file, and granting the customer viewing or retrieval privileges to the particular video and/or audio file, where the particular video and/or audio file is viewed or retrieved from the one or more remote servers for the customer.

The present invention provides contracted services to the presumed rights holder, and the rights holder conveys the right to view the video and/or audio program directly to the viewing consumer, aided by the mechanism of the present invention.

The present invention empowers the video and/or audio owner to grant viewing rights to one user at a time, retaining all other rights. Internet exhibition rights as a class do not have to be codified or documented, as no conveyance of this class of rights is required. By providing sales, distribution, and exhibition services as an application service provider, the present invention is not liable for rights disputes.

Accordingly, a system for merchandising digital programs over the World Wide Web is provided. The system for merchandising digital programs comprises a device having a storing means for storing one or more digital programs provided by an owner of the rights to the digital programs, ordering means for ordering one or more digital programs by a user from a web site through the device, the web site not having rights to the digital programs, and authorization means for obtaining authorization for the user from the owner to obtain the ordered one or more digital programs, wherein the one or more digital programs ordered by the user are streamed from the device directly to the user.

The system for providing digital programs over the world wide web further comprises a purchasing means for purchasing the one or more digital programs. The system can further comprise a billing means for providing payouts to the owner and the web site based on the amounts or percentages the owner and the web site are to receive.

Further, a method for providing digital programs over the world wide web is provided, the method comprising storing one or more digital programs provided by an owner of the rights to the digital programs in a device, providing an ordering means to a user to order one or more digital programs form a web site through the device, the web site not having rights to the digital programs, obtaining authorization for the user to obtain the ordered one or more digital programs, and streaming the one or more digital programs ordered by the user form the device directly to the user.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a block diagram a first embodiment of the video and/or audio ordering and delivering system according to the present invention.

FIG. 2 illustrates a block diagram a second embodiment of the video and/or audio ordering and delivering system according to the present invention.

FIG. 3 illustrates a block diagram a third embodiment of the video and/or audio ordering and delivering system according to the present invention.

FIG. 4 is a schematic flowchart that illustrates the steps of the method of present invention.

### DETAILED DESCRIPTION OF THE INVENTION

Although this invention is applicable to numerous and various types of online transactions, it has been found particularly useful in the environment of sales, distribution and exhibition of on-demand digital video and/or audio files and programs. Therefore, without limiting the applicability of the invention to the above, the invention will be described in such environment.

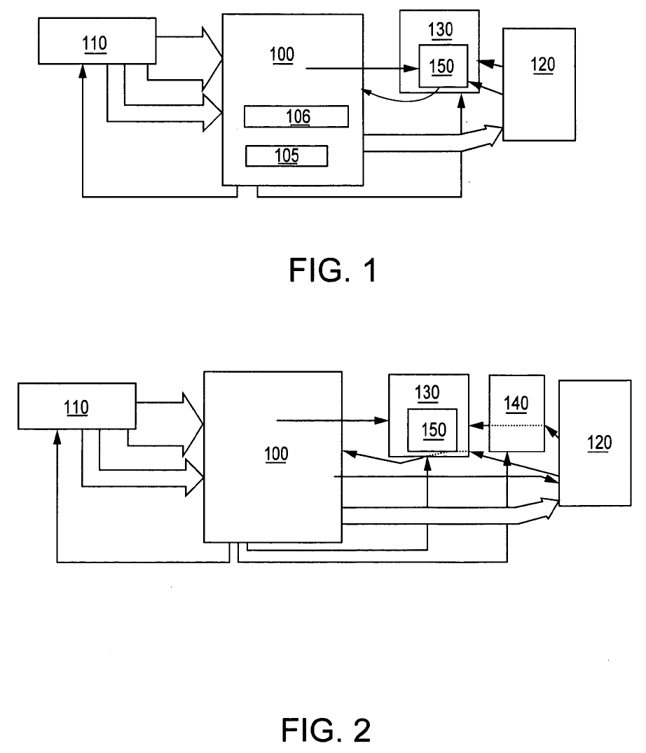

FIG. 1 illustrates a schematic representation of a digital video and/or audio delivering method and system in accordance with the present invention. An owner 110 of a video and/or audio program or file that wishes to sell or otherwise show that video and/or audio on the Internet provides a digital file version of the video and/or audio to be stored on a remote server. The owner 110 sends the video and/or audio files to a device 100. An owner 110 of video and/or audio provides video and/or audio in digital form to a device 100, and also provides rules regarding the rights to view the video and/or audio to the device 100. An online order form (not shown) may be generated for the owner 110 to fill out with the necessary information prior to providing the rights to view the video and/or audio to the device 100. This order form could release the device 100 or web site 130 from any liability. The files may be digitized by the device 100 if the files are not in digital form. Owner 110 can be an artist who created the video and/or audio themselves, or a company who has acquired the rights to the video and/or audio. The device 100 comprises remote servers that are not owned or operated by a web site 120a storing means 105, such as servers, that store the video and/or audio programs or files. Thus, access to. Typically, the video and/or audio come under the control of the device 100. Alternatively, the owner 110 can send the video and/or audio files to the web site 120, who forwards it on to the device 100, along with a completed marketability questionnaire program is digitized in the Windows Media video or audio format, encrypted with Microsoft Digital Rights management (DRM), and stored on Windows Media servers that are connected to the Internet. Other types of encoding or encryption may also be used.

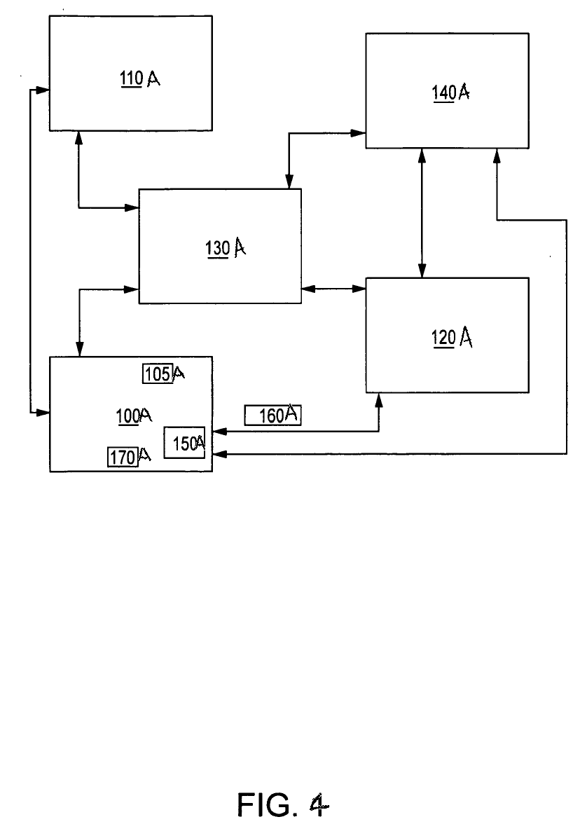

FIG. 4 illustrates device 100A, which reviews the video and/or audio content to see if it has adequate commercial potential. If so, the device 100A notifies the owner 110A and/or the website 120A of its willingness to provide server hosting, bandwidth, e-commerce transactions, and digital rights management/anti-piracy security.

From the remote audio servers, web users can view or otherwise retrieve the video and/or audio file(s). A customer 140A visiting the web site 120A can then request a listing of the video and/or audio files by clicking the appropriate link on the web site 120A. The availability of the video and/or audio for viewing is cataloged in one or more centralized databases. The databases are stored in the remote servers of the device 100A which presents listings of the web site's video and/or audio programs. The web site 120A can customize the appearance of the listings.

The web site 120A may choose to offer particular video and/or audio programs to its visitors. These selected entries in the database(s) are displayed by the web site 120A to the customer 140A. the customer 140A can see a listing of the selected entries, and then choose one or more entries to obtain the video and/or audio file for viewing and/or listening. The customer 140A can see a listing of the selected entries, and then choose one or more entries to obtain the video and/or audio file for viewing and/or listening. The customer 140A can search for a particular file, a group of files categorized by a certain category, or can view the entire listing of the video and/or audio files. The customer 140A can also view these listings by visiting a referral web site 130A instead of the web site 120A, such as by way of links on the referral web site's page. Each video and/or audio listing includes a “Buy Now” button.

If the customer 140A decides to purchase the video and/or audio file(s), the customer clicks on the “Buy Now” button or through some other means to purchase the video and/or audio file(s). An order page or order form (or appropriate HTML code) is provided for the web site 120A to display to the customer 140A, and the customer 140A can interact with the device's shopping cart. The device's billing system can maintain customer session and cookies to recognize returning customers.

The device 100A then charges the customer's credit card, or any other type of payment means can be used by the customer to purchase the video and/or audio files. The transaction is electronically processed on behalf of the owner 110A. The device then delivers the video and/or audio file to the customer 140A by streaming the video and/or audio to the customer 140A from the remove servers of the device 100A.

The owner 110A is notified of the transaction with the customer 140A. Revenue collected from the customer 140A can be distributed to cover costs, and the revenue can be divided appropriately between the parties, including the web site 120A, any referral web site 130A that may have directed the customer 140A to the ordering web site 120A and thereby earned a commission, and the owner 110A.

The present invention provides several advantages that solve the problems with prior art methods. The present invention provides a business model and method for providing video and/or audio on-demand service to owners of video and/or audio programs to offer digital versions of those programs to web site visitors. It is a method for using the World Wide Web to select and display database records of digital video and/or audio files that are available for retrieval over the Internet, and to publish the display to client web sites, such that visitors to that web site can choose to obtain or view, as may be permitted by the video and/or audio owner, the video and/or audio file, which is then delivered in digital format over the Internet, on behalf of the video and/or audio owner.

The method and apparatus function as an Application Service Provider (ASP), such that the client web site 120A need not install their own database or record retrieval and search functions, or e-commerce type functions for executing an order, but can avail themselves of the shared database (device 100A) and its functions, including a user interface to accept an order, and to appear on the web site 120A as if the web site operated their own database and e-commerce system.

The method and apparatus further provides conditional access to video and/or audio files which are named in the database records, and may be integrated with e-commerce or membership functions to permit the visitor to access one or a group of video and/or audio files. The method further stipulates that the video and/or audio files listed in the database are listed on behalf of the video and/or audio owner. Upon granting a web site visitor 140A access to a video and/or audio file(s), the device 100A provides an accounting of such access to the video and/or audio owner. This provides a filmmaker-direct-to-viewer marketplace.

The device 100a also provides for a billing means with transactional capabilities include the ability to share revenue with client web sites to encourage the web site to offer the video and/or audio files. Pricing for paid user access to the video and/or audio files can be set according to a number of different criteria, including dynamic pricing set by mathematical formulas which may include self negotiating market mechanisms and auction models. The device 100A through the billing means can also pay a referral fee to referral web sites 130A.

The present invention allows the content owner 130A to market their video and/or audio programs on their own volition, and to accept any risk or liability of possible rights disputes, so the web sites 120A do not have to. The transaction is completed by actual digital conveyance of the video and/or audio ordered, over the Internet. Further, the transaction, while executed by the device 100A, maintains the appearance that the sale is placed with the ordering web site 120A, and consummated with the video and/or audio rights owner 110A. The device 100A does not take orders directly, and therefore does not interfere or compete with ordering web sites 120A.

The invention uses a shared database system to list digital multimedia assets that can be delivered directly over the Internet. Whereas other Internet web sites may provide a list of items owned by individual companies on whose web sites the listings appear, the present invention may provide listings and ordering capabilities to appear on other web sites, where the web site is not the content owner and is not the seller. Each web site 120A may add database listings that are displayed solely on that web site 120A, but the listings the web site 120A submits for the invention would typically be for items owned by others. The web site 120A only needs to display the database listing of the item for sale, and the invention actually delivers the purchased digital media files on behalf of the owner 110A. The web site 120A does not need to own the inventory or actually fulfill the order.

The invention can also have customizable metadata, where documents such as the order forms and digital programs, have fields associated with them and associated rules for handling the documents. Customized fields and document types ensure an easier ordering and billing process.

Device 100 stores an order form 150 that is provided to an ordering web site 130. The ordering web site 130 can display an e-commerce shopping cart that offers one or more video and/or audio programs from the various video and/or audio programs that are stored in the servers of the device 100. The shopping cart is promulgated from the device 100, but can be accessed by visiting an ordering web site 130.

A visitor 120 of the web site 130 visits the web site 130 and is able to complete the order form 150 to purchase and view the video and/or audio. The device 100 also has a purchasing means where the web visitor 120 is provided payment options to purchase the rights to view the digital programs. After the web visitor 120 completes the order form 150 and provides payment information (such as credit card number), and the purchase is completed, this information is relayed to the device 100 through the ordering web site. A web visitor 120 that transacts with the shopping cart to purchase viewing of a video and/or audio program is provided DRM authorization on behalf of the owner 110 through an authorization means 106. The video and/or audio is then streamed to the web visitor 120, so that it can be viewed or listened to immediately, rather than by downloading. The web visitor 120 can then view the streaming video or listen to the streaming audio over the Internet connection, directly from the servers 105 of the device 100.

All such permissions and purchases are granted and maintained by the device 100. The device 100 can also be provided with a billing means that provides payouts to the owner 110, and to the ordering web site 130, depending on the amounts or percentages of the total sale that the owner 110 and the ordering web site 130 are to receive. The billings means of the device can also charge the owner 110 for the use of the device 100, or deduct the amount owed to the device 100 from the payout to be received by the owner 110.

A second embodiment of the present invention is provided in FIG. 2. This embodiment is similar to the first embodiment, except that a referral web site 140 is used that wishes to merchandise video and/or audio programs for which they are not an authorized ordering site such as web site 130. The referral web site 140 may become an affiliate/referral web site, and relay the web visitor 120 to the ordering web site 130 for the transaction when the web visitor 120 visits the referral web site 140.

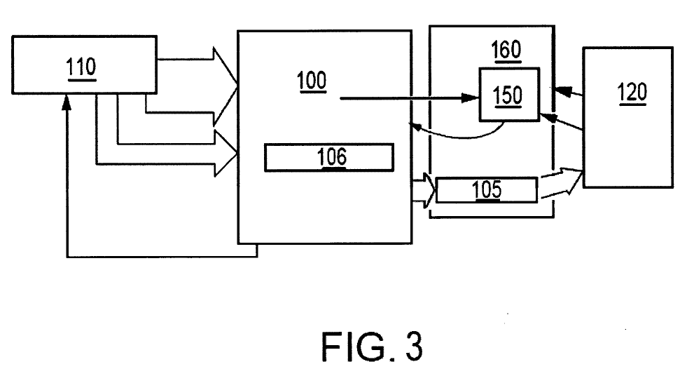

A third embodiment of the present invention is provided in FIG. 3. In this embodiment, the servers 105 can be connected to or located within an Internet Service Provider's (ISP's) central office 160, with the intent that the servers provide streaming video and/or audio to the ISP's own customers. The ISP would manage a purchase of the viewing of a video program or listening to an audio program, and payment may be included in the ISP's billing of their customers. The device 100 would maintain a record of all such payments and purchases.

The present invention provides several advantages that solve the problems with prior art methods. The present invention provides a system that permits an owner 110 of video and/or audio exhibition rights to merchandise viewings of the video and/or audio program from one or more web sites without transferring exhibition rights to the web site. The present invention provides services to the video and/or audio rights owner such as video and/or audio hosting on video and/or audio servers, for streaming delivery to viewers, connections to the video and/or audio servers to access the Internet or other IP-type networks, e-commerce order forms that can be propagated onto one or more web sites, e-commerce transactions, DRM authorizations for viewing, affiliate/referral tracking to identify sales that originate from other web sites, payouts of portions of the e-commerce transaction revenues generated to one or more owners 110, and payouts of portions of the e-commerce transaction revenues to one or more web sites that generate the sale.

Further, the video and/or audio rights owner 110 does not incur the costs of building, maintaining, or retaining the services of a commercial service for video and/or audio hosting, e-commerce software, credit card merchant accounts, or digital rights management encryption and DRM authorization license issuances. The ordering web site 130 does not incur the costs of obtaining exhibition rights, or the costs of video and/or audio hosting, e-commerce software, or credit card merchant accounts.

The invention can also have customizable metadata, such as criteria for matching content to websites. Prior art customizable metadata typically describes the title, the artist or principal actors, the year made, and one or two lines about the story, if applicable. The present invention provides customizable metadata that describes thematic, point-of-view, subject matter and other esoteric references triggered by the film or video property. These metadata references will be further customized to be accessible by web video search engines and targeted websites. Usually, the filmmaker or owner themselves, who knows the film most intimately, will do the first part of the customization. But the curator, or showcase webmaster, can perform the secondary customization.

The principal problems of internet digital media files are discovery, i.e. location of the file by interested consumers, and monetization. Customizable, human-generated thematic metadata is used to solve the first of these problems and the second problem follows. These ‘whole descriptors’ are one or any small number of machine-readable words that describe underlying or deep-meaning themes within the film or video.

Some movies are deliberately named obscurely. Others are named in a veiled reference to some aspect of the theme, but not the central theme of the movie. Use of human intelligence to derive the most fitting and comprehensive customizable metadata will enable fast and efficient ‘discovery’ of digital media files.

Contextual Metadata is about a sophisticated way to group and cross-reference video by genre and type, which will be central to the machine recognition and other advanced curatorial methods for digital media. A movie could well be both California, Film Noir and Los Angeles types and genres, for example. Both Thematic and Contextual Metadata can act to generate or cultivate the widest possible audience. As the internet is inherently worldwide, language would be another type of Contextual Metadata, as could be price, quality and format.

### EXAMPLE

As standard video listings on the Internet Movie Database (“IMDb”) and other databases and search, engines are not deeply descriptive; they do little to help young (or old) persons to find movies by theme. Film and video are proliferating online, and the problem of discovery has never been as challenging as it is today. An example of thematic metadata would be a movie whose title is totally unrelated to its content, such as “Being There” or “Clockwork Orange” for example. The only way to comprehensively aid these movies to find new audiences is to create alternate titles that refer to the movie, such as “South Cali Love Story” and “London Future Punk World,” etc.

The invention also provides for contextual syndication, where quality content is matched with relevant advertising. There is a syndication of videos to search engines and websites whose natural audience has a native interest in the themes of the video being searched, and therefore will be more likely to purchase a viewing of that video or other videos in a related theme. Contextual syndication allows for aggregation and categorization of the content by the device 100, and the device 100 matches the most relevant advertising videos and/or music with the users, depending on specific user preferences. The invention syndicates content to web sites 120 without any fee to the web site 120. The content syndicated is premium content for which a view must pay, and a portion of that payment is taken by the invention, in lieu of a fee. Advertisements can be sold based on this contextual reference.

The invention is unique because video and/or audio content owners 110 can use the invention's pay-per-view e-commerce software and the video and/or audio hosting service, without the owner 110 having to acquire software or pay a retainer to a hosting services provider, and without transferring exhibition rights to a video and/or audio web site 120.

The invention is also unique in that affiliate/referral sites 130A can forward web visitor traffic to another intermediary web site 120A, which in turn relays the sale to the owner 110A, yet does not require the owner 110A to become involved in fulfillment, as fulfillment is provided by the device 100A on behalf of the owner 110A. The invention is not a reseller, but is a broker.

The present invention likewise provides member web sites 120A the capability to display listings of video and/or audio files available for delivery over the network, but the files themselves are delivered from one or more central servers that are under control of the device 100A. The device 100A only listings of video and/or audio files on the web site 120A for which the originating web site 120A is previously authorized to market.

The present invention can also provide a self-contained portable system for accepting a video and/or audio input, and generating three simultaneous streams of video with audio output to a network. The system is compact and rugged, such that it can be carried or shipped to a video and/or audio production and easily accommodated in an existing video and/or audio production environment. Internal distribution allows a simply video and/or audio connection without any external devices or cables, other than the network output cable.

Typically, the network output cable is connected to a nearby Ethernet network that would in turn be connected to the Internet or to a private intranet. The system would convert the single video and/or audio input into three streams of video and/or audio data, suitable for live web casting, which in typical use is then forwarded to a streaming server located elsewhere on the Internet or intranet, and there they are replicated for multiple simultaneous users to access and receive the video and/or audio program on their computers. A custom software user interface immediately asks the user to select the desired stream types. Typically three different speeds can be chosen by the user to reach users that have different speeds of connection to the Internet or intranet, such as dial-up modems, ISDN or low level broadband, and medium level broadband suitable for cable-modems, DSL modems, or corporate networks.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A system for providing digital programs over the world wide web, the system comprising: a device having a storing means for storing one or more digital programs provided by an owner of the rights to the digital programs; ordering means for ordering one or more digital programs by a user from a web site through the device; and customizable metadata associated with the digital programs

2. The system for providing digital programs over the world wide web according to claim 1, further comprising: purchasing means for purchasing the one or more digital programs.

3. A system for providing digital on-demand content to be offered on a web site, the system comprising:
a. a directory of one or more available digital files provided on a website and stored on one or more remote servers, the directory including customizable metadata associated with a plurality of the available digital files;
b. ordering means to order one or more particular digital files;
c. transaction processing means to accept orders placed by a customer for the one or more particular digital files; and
d. delivering means for delivering the one or more particular digital files from the one or more remote servers to the customer.

4. The system for providing digital on-demand content to be offered on a web site according to claim 3, further comprising:
a. purchasing means for the customer to purchase the one or more digital files.

5. The system for providing digital on-demand content to be offered on a web site according to claim 3, further comprising:
a. a system for providing digital programs over the world wide web.

6. A method for providing digital on-demand content to be offered on a web site, the method comprising:
a. providing a listing to a customer of available video and/or audio files stored on one or more remote servers and selected from a directory based on a variety of search or filter criteria on a web site wherein some portion of the available files contain customizable metadata that may be searched by the customer;
b. generating an order form on the web site for the customer;
c. accepting orders placed by the customer on the web site for a particular video and/or audio file; and
d. granting the customer viewing or retrieval privileges to the particular video and/or audio file, where the particular video and/or audio file is viewed or retrieved from the one or more remote servers for the customer.
